(19) United States
(12) Patent Application Publication
(10) Pub. No.: US 2012/0063867 A1
(43) Pub. Date: Mar. 15, 2012

(54) Sheet Processing Apparatus and Method of Controlling the Same

(75) Inventor: Yoshiji Kanamoto, Tokyo (JP)

(73) Assignee: CANON KABUSHIKI KAISHA, Tokyo (JP)

(21) Appl. No.: 13/197,885

(22) Filed: Aug. 4, 2011

(30) Foreign Application Priority Data
Sep. 10, 2010 (JP) 2010-203299

(51) Int. Cl. B42C 19/02; B42C 5/00

(52) U.S. Cl. 412/1; 412/13

(57) ABSTRACT

A sheet processing apparatus that performs sheet processing with respect to a plurality of printed sheets and a method of controlling the apparatus are provided. A bookbinding process is performed with respect to a plurality of sheets, and pressure is applied to a spine of a bound stack of sheets to flatten the spine. At this time, the amount of pressure applied to the spine is set in advance, and a square back process is executed while controlling application of the pressure to the spine in accordance with the set pressure amount.

### BACKGROUND OF THE INVENTION

1. Field of the Invention

The present invention relates to a sheet processing apparatus and a method of controlling the sheet processing apparatus.

2. Description of the Related Art

In a conventional sheet processing apparatus, various types of sheet processing devices are connected to one another, and this makes it possible to create output matter in various forms by in-line processing (performing sheet processing on printed sheets subsequent to print processing). Specific examples of the sheet processing devices include a stapling device, a saddle stitching device, a puncher, a case binding device, and a sheet cutting device. With these sheet processing devices, printed sheets (media) can be processed into various forms.

For example, in a saddle stitching process of a saddle stitching device, processing of the output matter is controlled by following a procedure as described below. First, a central portion of a stack of sheets is stapled. Next, the stack of sheets is folded at the central portion along the direction of staples that have been attached during stapling. Finally, pressure is applied to the central portion of the folded stack of sheets, and thus bookbinding is performed. However, since the stack of sheets curves along the fold due to its elasticity, it is not possible to produce output matter in which a spine of the stack of sheets is flat. To address this issue, a device for shaping the fold of the spine into a flat surface by perpendicularly applying pressure to the spine of saddle-stitched output matter has been proposed (see Japanese Patent Laid-Open No. 2009-048412). A process of shaping in which pressure is perpendicularly applied to the spine of a book in this manner, thereby angulating the spine of the book is called a square back process (square folding process), and a device for performing such a process is called a square back device. It is possible not only to enhance the appearance of saddle-stitched matter but also to increase the ease of loading of the output matter by performing the square back process.

The problems at the time of output of saddle-stitched matter can be eliminated as described above by shaping the spine of a book into a flat surface using the square back device. However, conventional sheet processing apparatuses were not able to adjust the pressure applied to the spine of books during execution of the square back process. There is a diverse array of sheets that can be used to generate bound output matter, and owing to the sheet strength, for example, the required pressure to be applied to sheets to form a flat surface varies with the type of the sheets. For example, in the case of performing saddle stitching and the square back process using thin paper, the required pressure during folding can be relatively small because thin paper is thin compared with an ordinary sheet of, for example, plain paper. On the other hand, in the case of performing saddle stitching and the square back process using thick paper, the required pressure during folding must be relatively large because thick paper is thick compared with an ordinary sheet of, for example, plain paper.

Therefore, in the square back process, there is a possibility that the form of the bound output matter may be impaired unless the sheet type is taken into account as described above when applying the pressure. For example, in the case where the square back process is performed by applying an excessive pressure to output matter formed of thin paper, the shape of the spine of the resulting book may collapse. On the other hand, in the case where the square back process is performed by applying an insufficient pressure to bound output matter formed of thick paper, the shape of the spine of the resulting book may not be flattened due to insufficient pressure.

### SUMMARY OF THE INVENTION

An aspect of the present invention is to eliminate the above-mentioned problems with the conventional technology.

A feature of the invention of the present application is to provide a mechanism that can adjust the pressure applied to the spine of a book during execution of the square back process.

According to an aspect of the present invention, there is provided a sheet processing apparatus that performs sheet processing with respect to a plurality of printed sheets, comprising: a bookbinding unit adapted to perform a bookbinding process with respect to a plurality of sheets; a spine forming unit adapted to apply pressure to a spine of a stack of sheets bound by the bookbinding unit to flatten the spine; a setting unit adapted to set a pressure value of the pressure applied to the spine by the spine forming unit; and a control unit adapted to control application of the pressure to the spine by the spine forming unit in accordance with the pressure value set by the setting unit.

According to another aspect of the present invention, there is provided a method of controlling a sheet processing apparatus that performs sheet processing with respect to a plurality of printed sheets, the method comprising: a bookbinding step of a bookbinding unit of the sheet processing apparatus performing a bookbinding process with respect to a plurality of sheets; a spine forming step of a spine forming unit of the sheet processing apparatus applying pressure to a spine of a stack of sheets bound in the bookbinding step to flatten the spine; a setting step of a setting unit of the sheet processing apparatus setting a pressure amount of the pressure applied to the spine in the spine forming step; and a controlling step of a control unit of the sheet processing apparatus controlling application of the pressure to the spine in the spine forming step in accordance with the pressure amount set in the setting step.

Further features and aspects of the present invention will become apparent from the following description of exemplary embodiments, with reference to the attached drawings.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a diagram showing the configuration of a bookbinding system according to a first embodiment.

FIG. 2 is a block diagram illustrating the configuration of a printer apparatus according to the first embodiment.

FIG. 3 is a block diagram illustrating the configuration of a computer according to the first embodiment.

FIG. 4 depicts a top view illustrating a console unit of the printer apparatus.

FIG. 5 is a diagram illustrating various programs to be executed by a controller unit of the printer apparatus.

FIG. 6 is a diagram showing an example of the configuration of various programs on the computer according to the first embodiment.

FIG. 7 is a diagram illustrating the structure of a square back unit provided in a saddle stitching device.

FIG. 8A depicts a cross-sectional view of the square back unit taken along an auxiliary line 710 in FIG. 7.

FIG. 8B depicts a cross-sectional view of the square back unit taken along an auxiliary line 709 in FIG. 7.

FIGS. 9A and 9B depict enlarged views of the vicinity of a second press roller and a compression roller.

FIG. 10A depicts a cross-sectional view of saddle-stitched output matter before performing a square back process.

FIG. 10B depicts a cross-sectional view of the saddle-stitched output matter after performing the square back process.

FIG. 11A is a diagram showing an example of a setting screen of print jobs for saddle stitching that is displayed on the console unit of the printer apparatus.

FIG. 11B is a diagram showing an example of a setting screen that is displayed on the console unit immediately after a “Square back” button has been selected.

FIG. 12A is a diagram showing a saddle stitching setting screen that is displayed immediately after an “OK” button has been pressed on the screen in FIG. 11B.

FIG. 12B is a diagram showing an example of a screen that is displayed on the console unit immediately after an “Adjust” button has been selected.

FIG. 13 is a diagram showing an example of a screen that is displayed immediately after a “Square back adjustment” button has been pressed in FIG. 12B.

FIG. 14 is a flowchart for describing square-back-related processing that is processed by the controller unit of the printer apparatus according to the first embodiment.

FIG. 15A is a flowchart for describing the detail of processing in step S1403 in FIG. 14.

FIG. 15B depicts a view showing a graph for explaining the relationship between an adjustment value and a moving amount of the compression roller.

FIG. 16A is a diagram showing an example of a screen of a BOX function that is displayed on the console unit in the case where execution of a BOX function program has been instructed.

FIG. 16B is a diagram showing an example of page information constituting a job “Job C” that was in a selected state in FIG. 16A.

FIG. 17A is a diagram showing an example of a job edit screen that is displayed in the case where an “Edit job” button in FIG. 16A has been pressed.

FIG. 17B is a diagram showing an example of a setting edit screen of the job “Job C” that is displayed as a result of pressing an “Edit” button in FIG. 17A.

FIG. 18A is a diagram showing an example of a setting screen that is displayed after a “Saddle stitch” button has been pressed in FIG. 17B.

FIG. 18B is a diagram showing an example of a setting screen for partial bookbinding that is displayed after a “Partial bookbinding” button on the setting screen in FIG. 18A has been pressed.

FIG. 19 is a diagram showing an example of display of a warning screen according to a second embodiment.

FIG. 20 is a flowchart for describing processing related to display of the warning screen in processing of the BOX function according to the second embodiment.

FIG. 21 depicts a cross-sectional view illustrating the square back unit.

### DESCRIPTION OF THE EMBODIMENTS

Embodiments of the present invention will now be described hereinafter in detail, with reference to the accompanying drawings. It is to be understood that the following embodiments are not intended to limit the claims of the present invention, and that not all of the combinations of the aspects that are described according to the following embodiments are necessarily required with respect to the means to solve the problems according to the present invention.

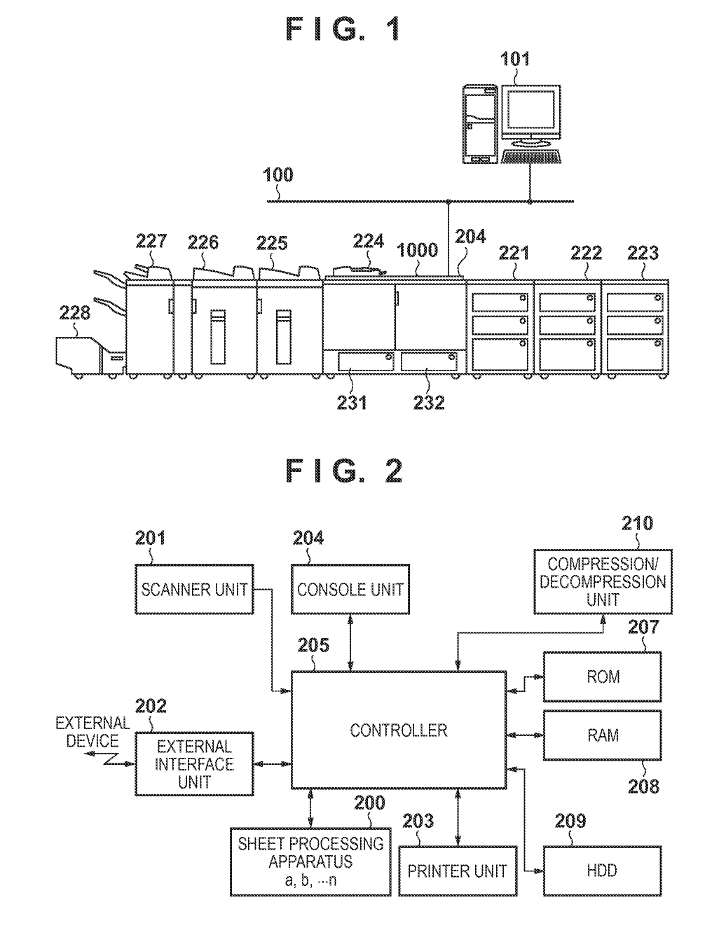

FIG. 1 is a diagram showing the configuration of a bookbinding system according to a first embodiment of the present invention. In FIG. 1, a plurality of devices are mutually connected and configured so as to perform complicated sheet processing. Detailed descriptions will be given below.

A printer apparatus 1000 prints an image onto a medium (a sheet) based on image data using a developer such as toner. A general configuration and the operating principle of this printer apparatus 1000 are as described below. A light beam, for example, a laser beam modulated according to the image data is made incident on a rotary polygon mirror (such as a polygon mirror), and thus a photosensitive drum is exposed to and scanned by scanning light reflected by the rotary polygon mirror. As a result, an electrostatic latent image according to the image data is formed on a surface of the photosensitive drum, and this electrostatic latent image is developed with the toner and transferred onto a sheet attached to a transfer drum. The above-described image forming process sequence is successively executed using individual colors yellow (Y), magenta (M), cyan (C), and black (K) of toner, and thus a full color image is formed. It is also possible to adopt a configuration in which spot color toner, clear toner, or the like can be transferred in addition to these four colors. The sheet on which the full color image was thus transferred is conveyed to a fixing unit. The fixing unit is composed of a combination of a roller and a belt, incorporates a heat source such as a halogen heater, and fuses and fixes the toner on the sheet, on which the toner image was transferred, by applying heat and pressure. It should be noted that a scanner unit 224 and a console unit 204 are provided in the printer apparatus 1000 according to the first embodiment. The console unit 204 is disposed on an upper face of the printer apparatus 1000. The console unit 204 provides various types of interfaces for use in the case where an operator performs various settings, operations, and the like of the printer apparatus 1000 according to the first embodiment.

Large-volume paper feeding devices 221, 222, and 223 are paper feeding devices that are configured so as to be removably connected to this bookbinding system. As shown in the diagram, a plurality of paper feeding devices can be connected, and therefore even a mass printing process can be continuously executed. Large-volume stackers 225 and 226 can stock a large number of printed sheets inside. A system provided with a large-volume paper feeding device such as the large-volume paper feeding devices 221 to 223 generates a large amount of printed matter and therefore requires a stacker such as these. In the configuration shown in FIG. 1, two large-volume stackers, that is, the large-volume stackers 225 and 226 are connected.

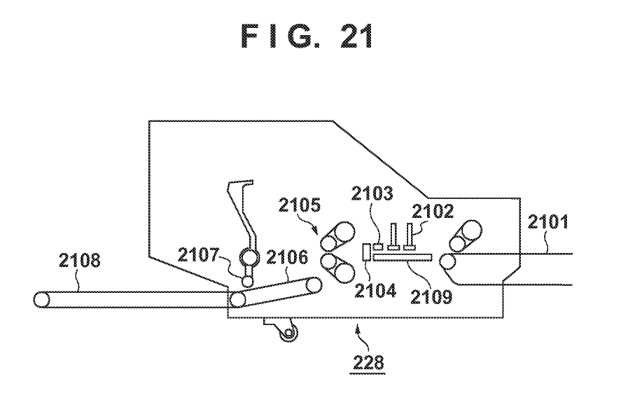

A saddle stitching device 227 is provided with various types of units with which a stapling process, a sheet cutting process, a punching process, a folding process, a shift discharge process, and the like of a plurality of sheets (a stack of sheets) printed in the printer apparatus 1000 can be selectively performed. Moreover, the saddle stitching device 227 also includes a square back unit (spine forming unit) 228 for performing processing so as to angulate a spine of saddle-stitched output matter. Details of the square back unit 228 will be described later using FIG. 21.

This bookbinding system can be considered as being broadly divided into three parts, with the printer apparatus 1000 serving as the boundary between the other two parts. In FIG. 1, devices that are disposed to the right of the printer apparatus 1000 are called paper feed type devices. A main function of the paper feed type devices is to successively supply sheets accommodated therein to the printer apparatus 1000 with proper timing. The paper feed type devices also perform functions such as detection of a remaining number of sheets accommodated in each of the large-volume paper feeding devices 221 to 223. Moreover, there are also sheet feed cassettes 231 and 232 within the printer apparatus 1000, and it is also possible to perform printing on sheets supplied from these sheet feed cassettes 231 and 232. These sheet feed cassettes 231 and 232 provided in the printer apparatus 1000 are also called paper feed type devices in the description.

On the other hand, in FIG. 1, the device that is disposed to the left of the printer apparatus 1000 is called a sheet processing device. This sheet processing device applies various types of processing to the sheets on which print processing has been completed, collects the printed sheets, and so on. The aforementioned paper feed type devices and the sheet processing device will be collectively referred to as a sheet processing apparatus 200 (FIG. 2) in the following description.

A computer (PC) 101 is a general-purpose computer device connected to the printer apparatus 1000 via the network 100. The PC 101 can execute various application programs and can send a print job to this printer apparatus 1000 and cause the printer apparatus to perform printing.

Next, the configuration of the printer apparatus 1000 according to the first embodiment will be described with reference to the block diagram in FIG. 2.

FIG. 2 is a block diagram illustrating the configuration of the printer apparatus 1000 according to the first embodiment.

This printer apparatus 1000 includes therein a non-volatile memory such as a hard disk 209 (hereinafter, an HDD) that is capable of storing data of a plurality of jobs to be processed. Moreover, the printer apparatus 1000 has a copy function of temporarily holding job data accepted from a scanner unit 201 (corresponding to the scanner unit 224 in FIG. 1) provided in the printer apparatus 1000 in the HDD 209, then reading out the job data from the HDD 209, outputting the job data to the printer unit 203, and performing printing. Furthermore, the printer apparatus has a PC print function for holding job data accepted from an external device such as the computer 101 via an external interface unit 202, which is an example of a communication unit, in the HDD 209 and printing the job data in the printer unit 203. The printer apparatus 1000 according to the first embodiment is a multi-function peripheral (an image forming device) having a plurality of functions such as those described above. In other words, the printer apparatus 1000 of the first embodiment can be either of a printing apparatus that is capable of printing in color and a printing apparatus that is capable of printing in monochrome.

The scanner unit 201 reads an original, performs image processing of image data of the read original, and outputs the image data to a controller 205. The external interface unit 202 exchanges image data and the like with a facsimile machine, a network connection device, and an external dedicated device. Moreover, the printer apparatus 1000 has the console unit 204 having a display unit, which is an example of a user interface unit. The controller (a control unit or a CPU) 205 performs integrated control of processing, operations, and the like of various units included in this printer apparatus 1000. A ROM 207 is a read-only memory and stores a boot program, font information, and the like. When a program is executed, a RAM 208 stores control programs including programs for executing various types of control processing and the like shown in flowcharts that will be described later. The control programs also include a display control program for displaying various UI screens on the display unit of the console unit 204. It should be noted that the various control programs are installed on the HDD 209, and when the power is turned on, the controller 205 executes the boot program in the ROM 207 and loads the control programs from the HDD 209 into the RAM 208, and thus the control programs are brought into an executable state.

The controller 205 executes the control programs loaded into the RAM 208, thereby interpreting PDL (page description language) data received from an external device (PC) via the external interface unit 202. Then, the controller 205 expands the PDL data into raster image data (bitmap data). Similarly, the controller 205 can also interpret and process a JDF job received from an external device (PC) via the external interface unit 202. The RAM 208 stores image data input from the scanner unit 201 or the external interface unit 202, various programs, setting information, and the like. The HDD (hard disk) 209 holds image data compressed by a compression/decompression unit (CODEC) 210, print data of a job to be processed, and the like. The controller 205 performs control so as to print data of jobs to be processed that have been input via various input units, such as the scanner unit 201 and the external interface unit 202, in the printer unit 203 via the HDD 209. The controller also performs control so as to send the data to an external device via the external interface unit 202. The CODEC 210 compresses/decompresses image data and the like stored in the RAM 208 or the HDD 209 using various compression schemes such as JBIG and JPEG. In the configuration as described above, the controller 205 also controls the operation of the sheet processing apparatus 200. It should be noted that the sheet processing apparatus 200 refers to the paper feed type devices and the sheet processing device is described with reference to FIG. 1.

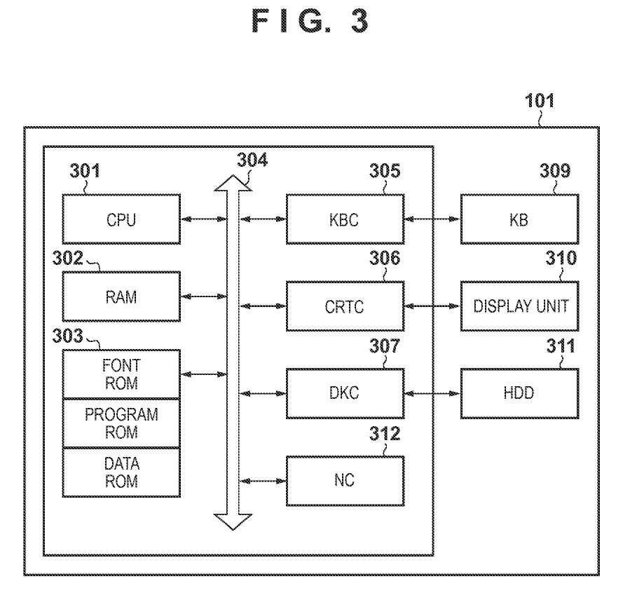

FIG. 3 is a block diagram illustrating the configuration of the computer (PC) 101 according to the first embodiment.

In this diagram, a CPU 301 executes programs, such as an OS, a general application, and a bookbinding application, stored in a program ROM in a ROM 303 or loaded from an HDD 311 into a RAM 302. The RAM 302 functions as a main memory, a work area, and the like of the CPU 301. A keyboard controller (KBC) 305 controls input from a keyboard (KB) 309 or a pointing device (not shown). A display controller (CRTC) 306 controls display to a display unit 310. A disk controller (DKC) 307 controls access to/from the HDD 311 or the like that stores a boot program, various applications, font data, user files, JDF files (described later), and the like. An NC 312 is connected to the network 100 and executes processing for controlling communication with other devices on the network 100. A system bus 304 connects the CPU 301 and the ROM 303, the RAM 302, the KBC 305, the CRTC 306, the DKC 307, and the NC 312, and transmits control signals and data.

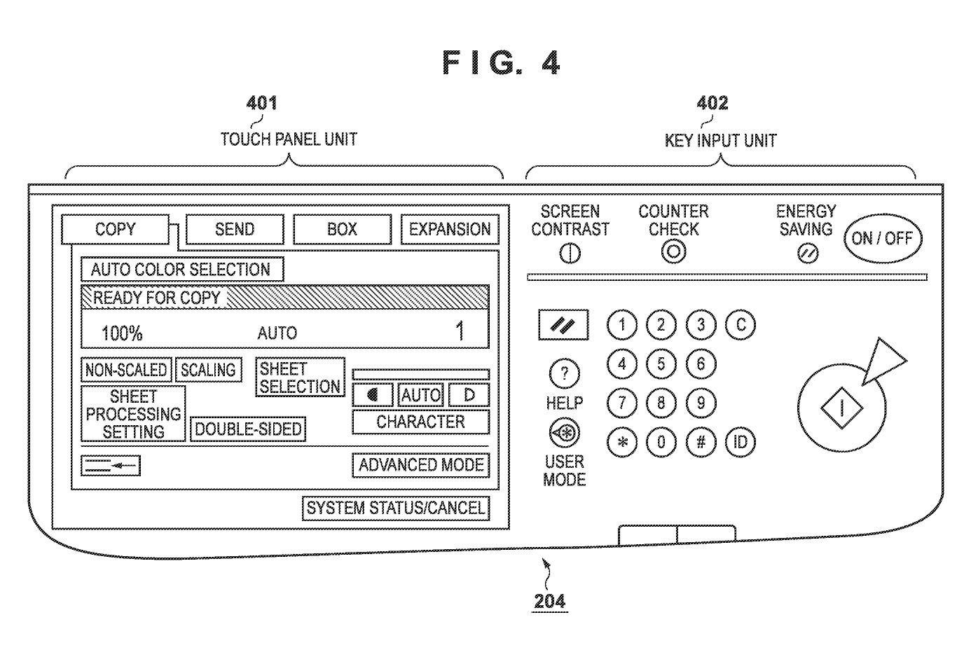

FIG. 4 depicts a top view illustrating the console unit 204 of the printer apparatus 1000.

The console unit 204 has a key input unit 402 for accepting a user operation through hard keys and a touch panel unit 401, which is an example of a display unit for accepting a user operation through soft keys (display keys). It should be noted that a screen that is displayed on the display unit of the touch panel unit 401 shown in FIG. 4 shows an example of a display screen displayed by the controller 205 via this display unit. The display items are changed according to the operation from the user or various statuses of the devices, and operable items also change each time the display items are changed.

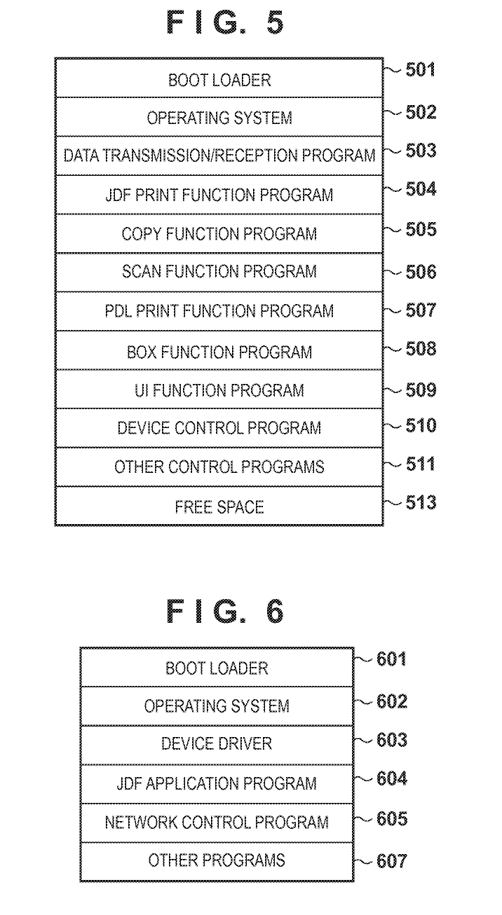

FIG. 5 is a diagram illustrating various programs executed by the controller 205 of the printer apparatus 1000 according to the first embodiment. These programs are installed on the ROM 207 or the HDD 209, and are expanded and executed in the RAM 208 at run-time.

A boot loader 501 is stored in the ROM 207, and is executed immediately after the printer apparatus 1000 is turned on. This boot program includes a program for executing various activation sequences that are necessary for activation of the system. Programs listed below are installed on the HDD 209. An operating system 502 is a program for providing execution environments of various programs that realize the functions of the printer apparatus 1000. The operating system 502 provides functions such as resource management of the memories, that is, the ROM 207, the RAM 208, the hard disk 209, and the like of the printer apparatus 1000, basic input/output control of various devices, and the like. A data transmission/reception program 503 performs transmission/reception processing, which is performed when a data input/output request occurs via the external interface unit 202. Specifically, the data transmission/reception program contains a protocol stack such as TCP/IP and controls communication of various types of data that are exchanged between the printer apparatus and an external device or the like that is connected via the network 100. The communication processing performed here is processing specialized for transmission/reception levels of data packets input/output between the printer apparatus 1000 and the external interface unit 202 and communication processing with an HTTP server and the like, and does not include analysis processing regarding the content of received data (described later). Data analysis processing is executed by the controller 205 (described later) based on the content of description of another program.

A JDF print function program 504 executes a JDF print function that is executed by the controller 205 according to an instruction from the external interface unit 204 once JDF job data has been received by the printer apparatus 1000 via the external interface unit 202. In the JDF print function that is executed by the controller 205, the controller 205 sequentially instructs operations of the individual devices in an appropriate order based on the processing sequence and processing conditions described in this program. As a result, control is performed so that JDF print processing is ultimately executed. These devices include the sheet processing apparatus 200, the printer unit 203, the hard disk 209, the CODEC 210, the RAM 208, and the like. Moreover, analysis processing of JDF job data that has been received via the external interface unit 202, determination processing for determining whether or not the JDF contains any wrong setting based on the result of analysis processing, and setting change for eliminating a wrong setting, and so on are performed. A copy function program 505 executes a copy function, which is executed by the controller 205, when the user of the printer apparatus 1000 has instructed execution of the copy function using the console unit 204. In this copy function, the controller 205 controls resources of the printer apparatus 1000 in appropriate order based on the processing order and processing conditions described in this program, and performs control so that copy processing is ultimately executed. The above-described devices include the scanner unit 201, the printer unit 203, the sheet processing apparatus 200, the hard disk 209, the CODEC 210, the RAM 208, and the like.

A scan function program 506 is executed by the user of the printer apparatus 1000 instructing execution of a scan function using the console unit 204. In this scan function, the controller 205 controls modules such as the scanner unit 201, the HDD 209, the CODEC 210, and the RAM 208 based on the processing order and processing conditions described in this program. At this time, control is performed by successively instructing operations of these individual devices in an appropriate order so that scan processing is ultimately executed. A PDL print function program 507 is executed when PDL job data has been received by the printer apparatus 1000 via the external interface unit 202. In this PDL print function, the controller 205 analyzes PDL data received from the external device (PC) 101 via the network 100, expands the PDL data into bitmap data, and performs printing in the printer unit 203 based on the bitmap data.

A BOX function program 508 is started by the user of the printer apparatus 1000 instructing execution of a BOX function using the console unit 204. In this BOX function, the controller 205 compresses data read by the scanner unit 201 and stores the compressed data in a BOX (a data storage area) in the HDD 209. Afterwards, the controller 205 reads out and decompresses the data stored in the BOX in the HDD 209 and prints the data with the printer unit 203. A UI function program 509 is a program for controlling the touch panel unit 401 and the key input unit 402 of the console unit 204. The UI function program 509 distinguishes the content input by the user of the printer apparatus 1000 through the console unit 204, and performs an appropriate screen transition and instructs a request for processing to the controller 205. A device control program 510 is a program for controlling various types of hardware such as the scanner unit 201 and the printer unit 203. Other control programs 511 are programs for realizing functions that do not correspond to any of the above-described programs. Reference numeral 513 indicates free space.

FIG. 6 is a diagram showing the configuration of various programs on the computer (PC) 101 according to the first embodiment.

A boot loader 601 is stored in the program ROM in the ROM 303. An operating system 602 is installed on the HDD 311, and is expanded in the RAM 302 by the boot loader 601 in the ROM 303 when the power is turned on. A device driver 603 is a program for controlling various types of hardware connected to the computer 101. This program also contains programs for controlling the KBC 305, the CRTC 306, the DKC 307, and the like. A JDF application program 604 is a generic name for programs that run on the computer 101 and that aim to provide various functions and services to the user of a POD (Print On Demand) system. This JDF application program 604 has a function of creating or editing JDF job data. Moreover, similarly, the JDF application program 604 has a function of converting various print specifications that have been set through a setting screen (not shown) of this application program to corresponding JDF settings. Furthermore, conversely, this JDF application program 604 is also capable of converting settings contained in the JDF to internal information that is required in order to control items to be displayed on a corresponding setting screen of the JDF application program 604. Furthermore, the JDF application program 604 also has a function of selecting a JDF file stored in the HDD 311 and creating JDF job data. A network control program 605 is executed when JDF document data created by the JDF application program 604 is sent as a print job to the printer apparatus 1000 that is connected via the network 100. This network control program 605 also has functions of sending print data, and after that, acquiring the progress of print processing as progress information of a print job executed by the printer apparatus 1000 connected to the computer 101, and so on. Other programs 607 include all the programs that do not correspond to any of the above-described programs; however, descriptions thereof will be omitted.

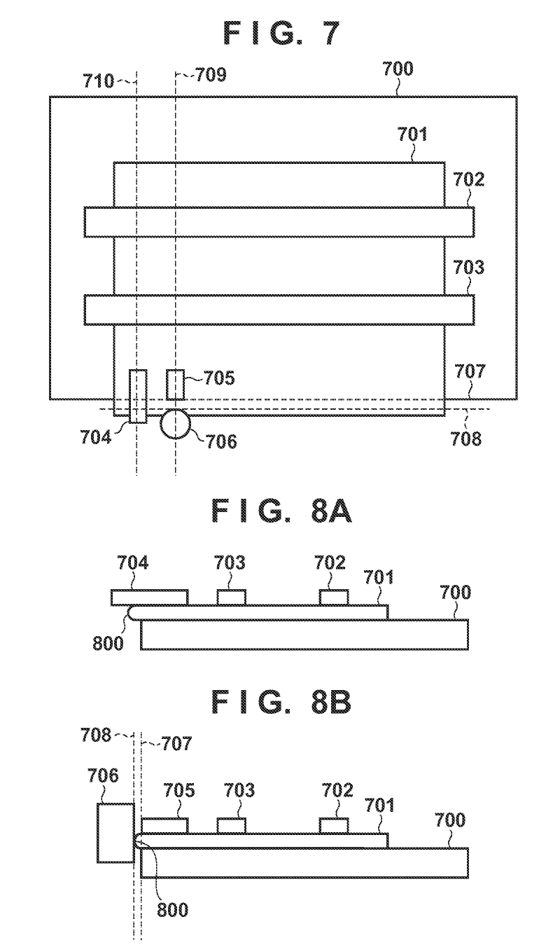

FIG. 7 is a diagram illustrating the structure of a square back unit 228 provided in the saddle stitching device 227 according to the first embodiment.

First, details of the square back unit 228 will be described using the cross-sectional view in FIG. 21.

The square back unit 228 is provided in the saddle stitching device 227. Saddle-stitched output matter that has been saddle-stitched by the saddle stitching device 227 is conveyed by a conveyance belt 2101 with a spine of the saddle-stitched output matter as the leading edge in the conveyance direction and is received by the square back unit 228.

In the square back unit 228, the received saddle-stitched output matter is conveyed by conveyance rollers on a conveyance path until the spine of the saddle-stitched output matter comes into contact with a compression roller 2104. Once the spine of the saddle-stitched output matter has come into contact with the compression roller 2104, clamp units 2102 are brought into contact with the saddle-stitched output matter, thereby fixing the position of the saddle-stitched output matter between the clamp units 2102 and a base 2109. Then, the spine of the saddle-stitched output matter is angulated by the compression roller 2104 pressing against the spine of the saddle-stitched output matter while a press roller 2103 presses against the vicinity of the spine of the saddle-stitched output matter. Then, the compression roller 2104 is removed from the conveyance path of the saddle-stitched output matter, and the saddle-stitched output matter is conveyed toward discharge rollers 2105 and is discharged onto a discharge roller 2106. The saddle-stitched output matter discharged onto the discharge roller 2106 is discharged onto a discharge tray 2108 by the discharge roller 2106 and a discharge roller 2107. The user receives the saddle-stitched output matter discharged to the discharge tray 2108.

FIG. 7 is a diagram showing the vicinity of the clamp units 2102 of the square back unit 228 such as described above. It should be noted that FIG. 7 shows the sheet conveyance path as seen from the direction of the clamp units 2102 (from above) in FIG. 21.

In the square back unit 228, various units are disposed above the base 700 as shown in FIG. 7. That is to say, saddle-stitched output matter 701 to be processed is placed as shown in this diagram. This saddle-stitched output matter 701 has already been stapled and folded by the saddle stitching device 227, and thereafter is conveyed by rollers from the top toward the bottom of the diagram to this square back unit. At this time, the saddle-stitched output matter 701 is conveyed in such a manner that an upper side of the output matter in FIG. 7 is a fore-edge side and a lower side is the spine.

A first clamp unit 702 and a second clamp unit 703 correspond to the clamp units 2102 in FIG. 21. The first clamp unit 702 and the second clamp unit 703 are fixed plates that are provided in order to bring the saddle-stitched output matter 701 into close contact with the base 700 (corresponding to the base 2109 in FIG. 21) when performing the square back process. The saddle-stitched output matter 701 conveyed from the saddle stitching device 227 is sandwiched between the first and second clamp units 702 and 703 and the base 700. The first clamp unit 702 and the second clamp unit 703 prevent the saddle-stitched output matter 701 from slipping out of place during formation of the spine of the saddle-stitched output matter 701. A first press roller 704 applies pressure perpendicularly (in a direction perpendicular to FIG. 7) to a face of the saddle-stitched output matter 701 in order to reduce bulging in the neighborhood of the fold of the saddle-stitched output matter 701. This roller 704 moves from the left edge to the right edge (or in reverse) in FIG. 7, thereby performing a pressing process on the saddle-stitched output matter 701.

On the other hand, a compression roller 706 corresponds to the compression roller 2104 in FIG. 21. The compression roller 706 is a roller for applying pressure in a direction orthogonal to the direction of the pressure applied by the press roller 704 (in a direction perpendicular to the spine (from the bottom toward the top in FIG. 7)) in order to angulate the spine of the saddle-stitched output matter 701 to give a flat surface to the spine. The compression roller 706 is supported by a support that can move upward and downward in FIG. 7. This support is moved upward or downward in FIG. 7 according to an instruction from the controller 205, and accordingly, the compression roller 706 moves upward or downward in FIG. 7 as well. This makes it possible to adjust the pressure applied to the spine during formation of the spine. In the case where the roller moves upward, the pressure applied to the spine of the saddle-stitched output matter 701 increases, and in the case where the roller moves downward, the pressure applied to the spine of the saddle-stitched output matter 701 decreases. This compression roller 706 moves from the left edge to the right edge (or in reverse) in FIG. 7 as well, thereby performing the pressing process on the spine of the saddle-stitched output matter 701. A second press roller 705 corresponds to the press roller 2103 in FIG. 21. The second press roller 705 is a unit paired with the compression roller 706 and presses against a cover surface of the saddle-stitched output matter 701 in the perpendicular direction (the direction perpendicular to FIG. 7). The second press roller 705 is supported by a support extended along an auxiliary line 709 in FIG. 7. This support is moved to the back or to the front in FIG. 7 according to an instruction from the controller 205, and accordingly, the compression roller 706 is moved to the back or to the front in FIG. 7 as well. It should be noted that although the surface of the press roller 705 and the compression roller 706 herein is assumed to be made of a metal composing the rollers, the surface of the rollers may be formed of a hard rubber material that is required in order to apply pressure to sheets. With these two rollers 705 and 706, it is possible to angulate the spine of the saddle-stitched output matter 701 so as to give a higher-quality flat surface. That is to say, a portion of the sheets composing the saddle-stitched output matter 701 sandwiched between the compression roller 706 and the second press roller 705 is pressed by these rollers 705 and 706. As a result, the square back process, in which the spine is angulated with respect to the surface of the cover of the saddle-stitched output matter 701 and is formed into a linear shape, is applied. In this manner, by moving the rollers 705 and 706 from the left edge to the right edge (or in reverse) in FIG. 7, the pressing process is applied to the entire spine of the saddle-stitched output matter 701.

It should be noted that although it is also possible to move the first press roller 704, the second press roller 705, and the compression roller 706 independently, in the description of the first embodiment, it is assumed that these rollers are moved integrally as a single roller unit. However, the case where a configuration of independently moving the first press roller 704, the second press roller 705, and the compression roller 706 is adopted is also encompassed by the present invention.

Moreover, the position of the compression roller 706 relative to that of the second press roller 705 can be adjusted by the controller 205. The distance between the two rollers 705 and 706 can be adjusted by adjusting the position of the compression roller 706. That is to say, it is possible to adjust the amount of pressure applied to the spine of the saddle-stitched output matter 701 by adjusting the distance between the two rollers 705 and 706.

It should be noted that an auxiliary line 707 shown in FIG. 7 indicates the positions of a leading edge of the second press roller 705 and a leading edge of the base 700. An auxiliary line 708 indicates the position at which the compression roller 706 performs pressing. The auxiliary line 709 indicates a line passing through the center of the compression roller 706 and the second press roller 705 and will be used when describing a cross-sectional view of the square back unit with reference to FIG. 8B. Similarly, an auxiliary line 710 indicates a line passing through a center portion of the first press roller 704 and will be used when describing a cross-sectional view of the square back unit with reference to FIG. 8A.

FIG. 8A depicts a cross-sectional view of the square back unit taken along the auxiliary line 710 in FIG. 7, and FIG. 8B depicts a cross-sectional view of the square back unit taken along the auxiliary line 709 in FIG. 7. It should be noted that in FIGS. 8A and 8B, the same portions as those in FIG. 7 described above are denoted by the same reference numerals.

In FIG. 8A, the saddle-stitched output matter 701 is fixed by the base 700, the first clamp unit 702, and the second clamp unit 703, and the first press roller 704 applies pressure to the saddle-stitched output matter 701. Thus, processing for preventing the saddle-stitched output matter 701 from bulging is applied.

In FIG. 8B, the saddle-stitched output matter 701 is fixed by the base 700, the first clamp unit 702, and the second clamp unit 703. In this state, the second press roller 705 and the compression roller 706 apply pressure in order to angulate a spine 800 of the saddle-stitched output matter 701 to give a flat surface to the spine. Thus, bulging of the spine 800 of the saddle-stitched output matter 701 as shown in FIG. 8A is corrected, and the spine is flat.

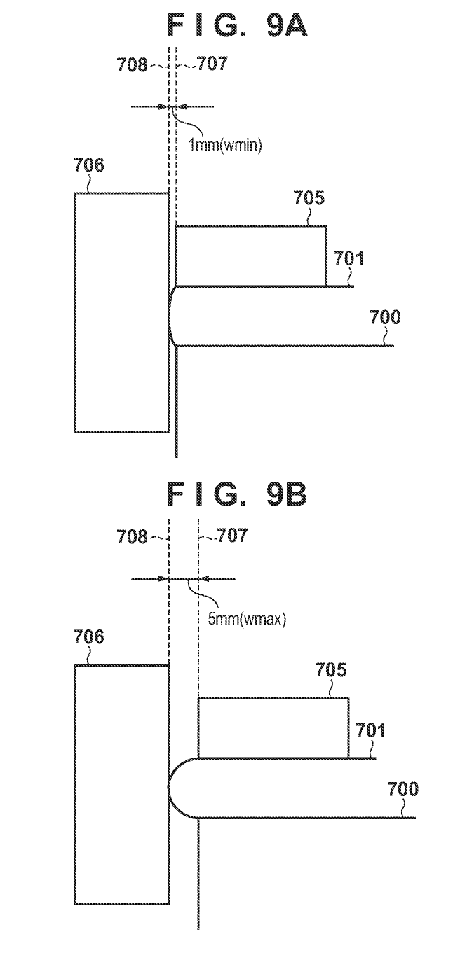

FIG. 9A is a diagram showing an enlarged view of the vicinity of the second press roller 705 and the compression roller 706 in the cross-sectional view in FIG. 8B. FIG. 9A shows a state in which the distance between the second press roller 705 and the compression roller 706 is controlled so as to be minimized according to an instruction from controller 205. The distance between the auxiliary line 707 and the auxiliary line 708 in this case is a minimum length (w(min)) controllable by the square back unit. It is not possible to perform control so as to reduce the distance to a smaller length than this minimum length. By creating such a state, the pressure applied to the spine of the saddle-stitched output matter 701 during the square back process can be maximized.

FIG. 9B is a diagram showing an enlarged view of another example of the vicinity of the second press roller 705 and the compression roller 706 in the cross-sectional view in FIG. 8B. Here, a state in which the distance between the second press roller 705 and the compression roller 706 is controlled so as to be maximized according to an instruction from the controller 205. The distance between the auxiliary line 707 and the auxiliary line 708 in this case is a maximum length (w(max), set to 5 mm here) controllable by the square back unit. It is not possible to perform control so as to increase the distance to a larger length than this maximum length. By creating such a state, the pressure applied to the spine of the saddle-stitched output matter 701 during the square back process can be minimized.

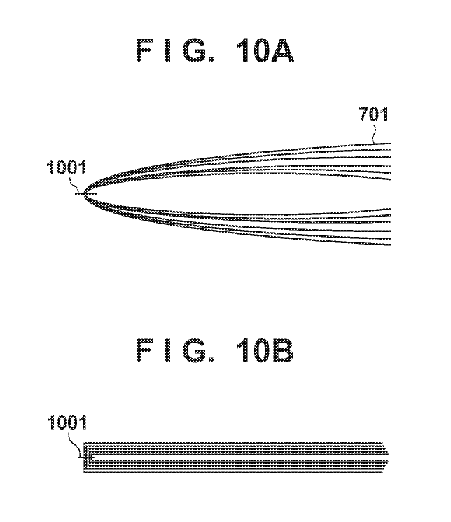

FIG. 10A depicts a cross-sectional view of the saddle-stitched output matter 701 before the square back process according to the first embodiment is performed. As shown in this diagram, a staple 1001 is attached to a position corresponding to the fold of the saddle-stitched output matter 701 and binds together the sheets composing the saddle-stitched output matter 701. Here, the spine has a shape bulging along the fold due to the elasticity of the sheets composing the saddle-stitched output matter 701.

FIG. 10B depicts a cross-sectional view of the saddle-stitched output matter 701 after the square back process according to the first embodiment has been performed. As shown in this diagram, it can be seen that the position corresponding to the fold of the saddle-stitched output matter 701 is angulated, and the spine is flattened. This shape is formed as a result of application of the pressure to the spine of the saddle-stitched output matter 701 by the second press roller 705 and the compression roller 706, which have been described with reference to FIGS. 7 to 9A and 9B.

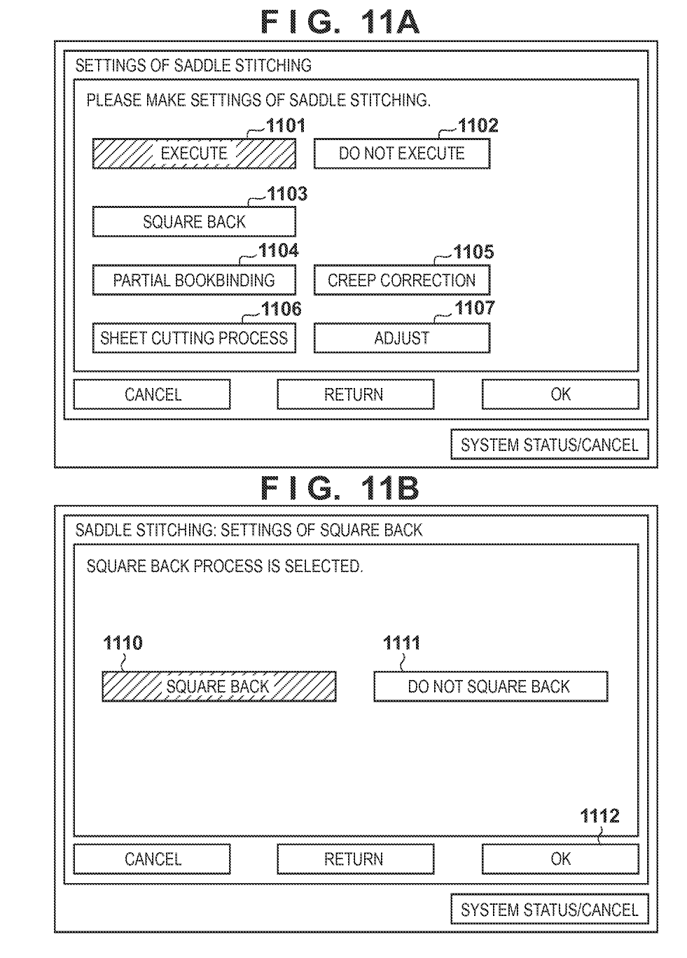

FIG. 11A is a diagram showing an example of a setting screen that is displayed on the console unit 204 of the printer apparatus 1000 and is used in executing a print job of saddle stitching. This screen is displayed by the copy function program 505 in FIG. 5 executing a print job. However, the print job type according to the first embodiment is not limited to that of the copy function program 505. The first embodiment is also applicable to other print-related jobs supported by the printer apparatus 1000, such as those of the JDF print function program 504 and the PDL print function program 507.

An “Execute (saddle stitch)” button 1101 and a “Do not execute” button 1102 are setting buttons that can be selected exclusively. In FIG. 11A, the “Execute” button 1101 is selected, and the “Do not execute” button 1102 is in an unselected state. The select function of these buttons on the console unit 204 is controlled by the UI function program 509 that is executed by the controller 205.

A “Square back” button 1103 is a button for selecting whether or not a square back function, which is supported by the printer apparatus 1000 and is performed by the saddle stitching device 227, is to be used. In FIG. 11A, the square back function is in an unselected state. In FIG. 11A, furthermore, other function select buttons related to the saddle stitching process are disposed. That is to say, a “Partial bookbinding” button 1104 that is used when generating a plurality of pieces of saddle-stitched output matter by a single job is disposed. Moreover, a “Creep correction” button 1105 for designating a creep process of saddle stitching is disposed. Moreover, a “Sheet cutting process” button 1106 for cutting a fore-edge and head and tail ends of the saddle-stitched output matter and an “Adjust” button 1107 for executing various types of adjustment regarding the functions related to saddle stitching are disposed.

FIG. 11B is a diagram showing an example of a setting screen that is displayed on the console unit 204 if the “Square back” button 1103 is selected in FIG. 11A.

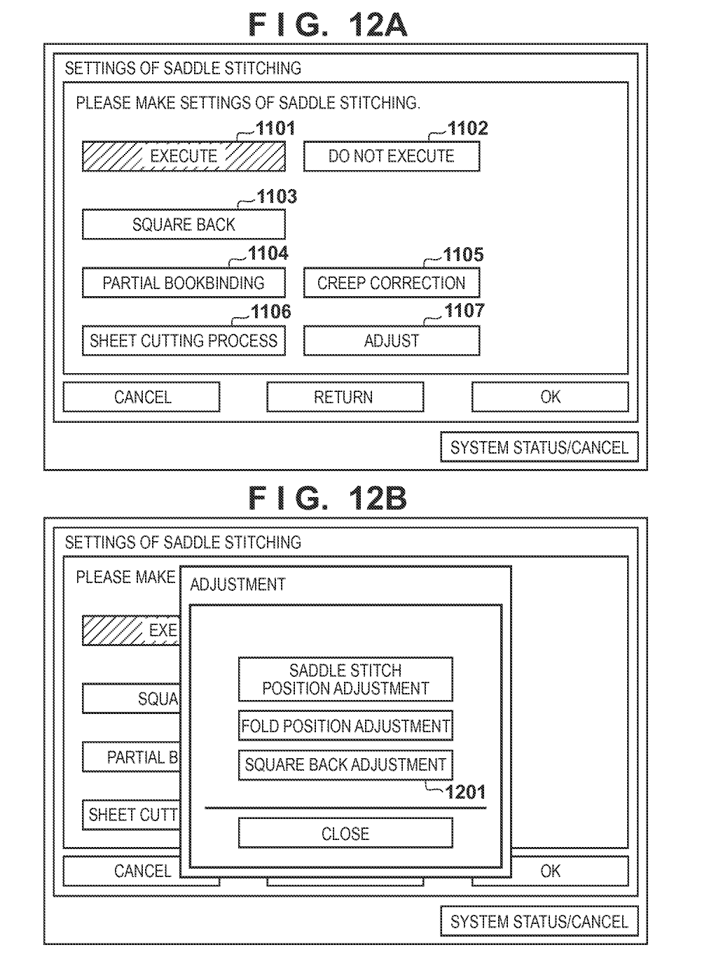

An “Execute (square back)” button 1110 for selecting the square back function and a “Do not execute” button 1111 for deselecting the square back function are disposed. FIG. 11B shows a state in which the “Execute” button 1110 is selected. If an “OK” button 1112 is pressed in this state, the screen changes to a screen shown in FIG. 12A while the state in which the function of the button 1110 is selected is maintained.

FIG. 12A is a diagram showing a setting screen for saddle stitching that is displayed immediately after the “OK” button 1112 is pressed in the screen shown in FIG. 11B. In FIG. 12A, the same portions as those in FIG. 11A are denoted by the same reference numerals. As is apparent from comparison with FIG. 11A, the “Square back” button 1103 is in the selected state, which indicates that the setting for the square back process has been designated.

FIG. 12B is a diagram showing an example of a screen that is displayed on the console unit 204 immediately after the “Adjust” button 1107 is selected in FIG. 12A or 11A. In FIG. 12B, a plurality of adjustment functions related to the saddle stitching process are in a selectable state. Descriptions of the adjustment functions for functions that are little related to the description of the effect of the present embodiment will be omitted.

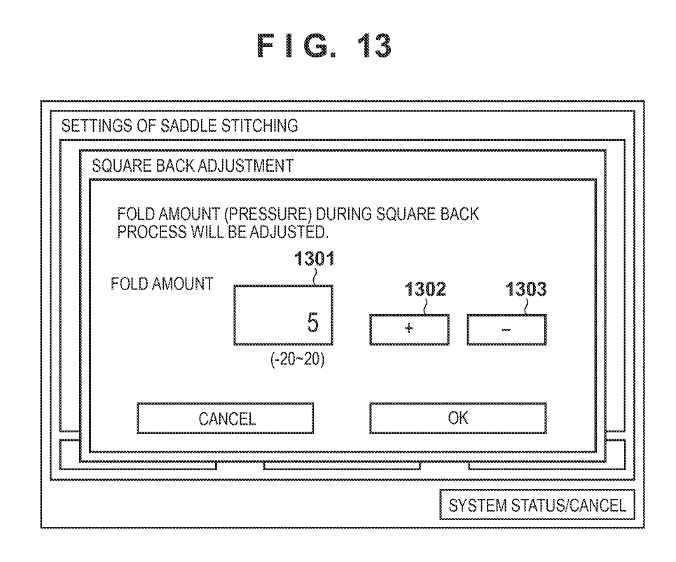

In FIG. 12B, if a “Square back adjustment” button 1201 is pressed, the screen changes to an adjustment screen for the square back process in FIG. 13.

FIG. 13 is a diagram showing an example of a screen that is displayed immediately after the “Square back adjustment” button 1201 in FIG. 12B is pressed.

FIG. 13 shows the screen for setting a value for adjustment of the pressure to be applied to the spine of the saddle-stitched output matter 701 by the second press roller 705 and the compression roller 706 during execution of the square back process. That is to say, based on the value represented by an adjustment amount 1301 in this diagram, the position of the compression roller 706 relative to that of the second press roller 705 is controlled by the controller 205. As a result, the pressure that these rollers 705 and 706 apply to the spine of the saddle-stitched output matter 701 can be controlled.

A plus (+) button 1302 and a minus (−) button 1303 are buttons for increasing and decreasing the value of the adjustment amount 1301, and each time the plus button or the minus button is pressed, 1 is added to or subtracted from the adjustment amount value. However, an upper limit value and a lower limit value of the adjustment amount are predetermined, and adjustment to a value exceeding these limit values is not allowed. In the first embodiment, the adjustment amount has a maximum value of “+20” and a minimum value of “−20”. If the maximum value is set, the controller 205 arranges the second press roller 705 and the compression roller 706 in a manner as shown in FIG. 9A described above. On the other hand, if the minimum value is set, the controller 205 arranges the second press roller 705 and the compression roller 706 in a manner as shown in FIG. 9B described above.

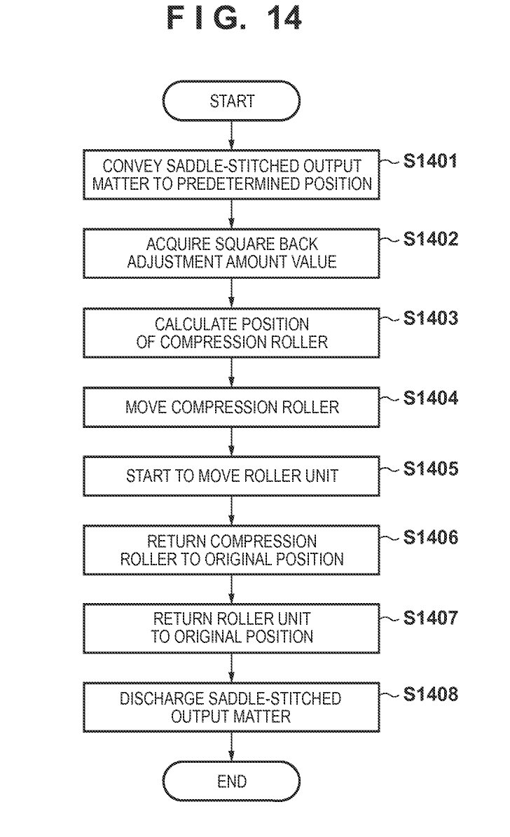

FIG. 14 is a flowchart for describing processing regarding the square back process that is executed by the controller 205 of the printer apparatus 1000 according to the first embodiment. This processing is executed by controlling the saddle stitching device 227 (the sheet processing apparatus) by means of the copy function program 505. It should be noted that among the operations of this copy function program 505, details of operations that are performed before and after the square back process are not essential in describing the present embodiment and therefore will be omitted. This processing is realized by the controller 205 executing a program loaded into the RAM 208.

First, in step S1401, the controller 205 conveys the saddle-stitched output matter 701 to a predetermined position in the saddle stitching device 227. That is to say, the controller 205 causes the saddle-stitched output matter 701 to be conveyed to a position indicated by the leading edges of the base 700 and the second press roller 705 in the square back unit shown in FIG. 7.

Next, the processing proceeds to step S1402, in which the controller 205 acquires the value of the adjustment amount for the square back process. This means that the value of the adjustment amount 1301 that is set in FIG. 13 is acquired as this adjustment amount. Next, the processing proceeds to step S1403, in which a position of the compression roller 706 is obtained by calculation based on the value of the adjustment amount acquired in step S1402. The content of this calculation process will be described later.

Next, the processing proceeds to step S1404, in which the controller 205 moves the compression roller 706 to the position obtained in step S1403. This moving process is performed by the saddle stitching device 227 moving the compression roller 706 according to an instruction from the controller 205. It should be noted that this move corresponds to moving the compression roller 706 upward or downward in FIG. 7.

Next, the processing proceeds to step S1405, in which the controller 205 executes the square back process by moving a roller unit including the first press roller 704, the second press roller 705, and the compression roller 706. That is to say, the controller 205 moves the roller unit over the saddle-stitched output matter 701 conveyed in step S1401, thereby angulating the spine of the saddle-stitched output matter 701 and giving the spine a flat surface. This is as described above with reference to FIGS. 7, 8A, 8B, 9A, 9B and 10B.

When the spine forming processing of the saddle-stitched output matter 701 by means of the roller unit has been completed in this manner in step S1405, the processing proceeds to step S1406, in which the controller 205 returns the position of the moved compression roller 706 to a predetermined position. This predetermined position is the position shown in FIG. 7.

Next, the processing proceeds to step S1407, in which the controller 205 returns the roller unit that has moved to the right edge or the left edge of the square back unit to a standby position again. Then, the processing proceeds to step S1408, in which the controller 205 discharges the saddle-stitched output matter 701 and ends the square back process.

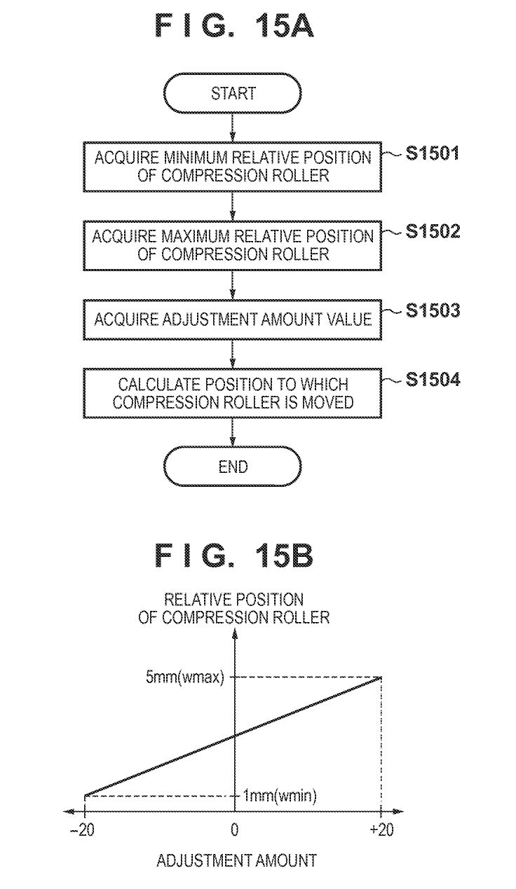

FIG. 15A is a flowchart for describing the details of the process for calculating the position of the compression roller 706 relative to that of the second press roller 705 in step S1403 in FIG. 14. Here, the position of the compression roller 706 relative to that of the second press roller 705 is obtained. This process is performed by the controller 205 executing a program loaded into the RAM 208.

First, in step S1501, the controller 205 acquires information on a minimum relative position of the compression roller 706. This information is held by the copy function program 505 and is acquired by the controller 205 controlling this program.

Next, the process proceeds to step S1502, in which the controller 205 acquires information on a maximum relative position of the compression roller 706. This information is held by the copy function program 505 and is acquired by the controller 205 controlling this program.

Next, the process proceeds to step S1503, in which the controller 205 acquires the value of the adjustment amount acquired in step S1402 in FIG. 14. Next, the process proceeds to step S1504, in which the position of the compression roller 706 relative to that of the second press roller 705 is calculated based on the numerical values acquired in steps S1501, S1502, and S1503.

FIG. 15B is a graph for explaining a relationship between the adjustment amount and the relative position of the compression roller 706, which can be obtained from the numerical values obtained in steps S1501, S1502, and S1503 in FIG. 15A.

As shown in this graph, the adjustment amount for the square back process input on the screen in FIG. 13 and the maximum and minimum relative positions of the compression roller 706 are represented by a function shown in the graph. That is to say, the function is a linear function whose input is the adjustment amount and having a domain from “−20” to “+20” and a range from w(min) to w(max). In this example, w(min) is set to 1 mm, and w(max) is set to 5 mm; however, these values can be changed depending on the mechanical structure of the saddle stitching device.

The function that defines the relationship between the adjustment amount and the position of the compression roller 706 relative to that of the second press roller 705 may be a function other than that shown in this graph. However, the difference between such functions is based on the difference due to the properties of the functions represented by this graph, and the nature of the present embodiment that the position of the compression roller 706 relative to that of the second press roller 705 can be obtained by this function remains the same. Therefore, whatever function is applied, the present invention is effective as long as the matters as set forth in the claims are met.

The first embodiment was described using, as an example, the case where in a copy job, the saddle stitching process was set, and at the same time, the square back process was selected. Next, a second embodiment will be describe below using, as an example, a case where the BOX function program 508 in FIG. 5 is executed by the controller 205. It should be noted that the system configuration and the like including the printer apparatus 1000 according to the second embodiment are the same as those in the above-described first embodiment, and therefore descriptions thereof will be omitted.

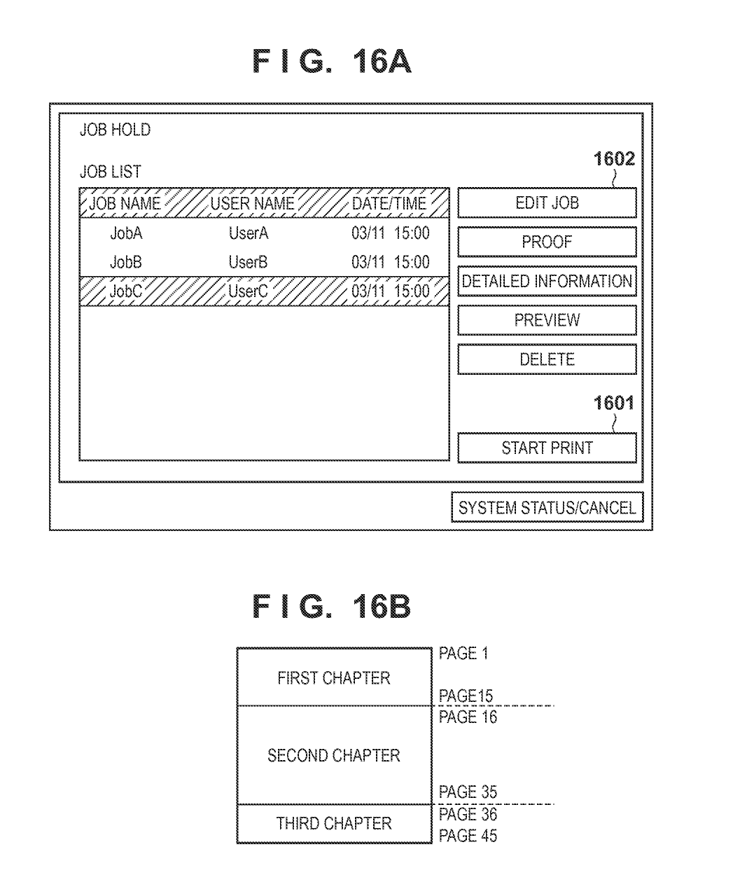

FIG. 16A is a diagram showing an example of a screen of a BOX function that is displayed on the console unit 204 in the case where execution of the BOX function program 508 has been instructed on the console unit 204.

The BOX function is a function of printing image data stored in the HDD 209, which is managed by the printer apparatus 1000, on the printer unit 203. To store the image data in the HDD 209 using the BOX function, an original is scanned and read out by the scanner unit 201, and image data that has been read out is stored. Alternatively, data of a PDL job input via the external interface unit 202 is processed by the PDL print function program 507 and stored in the HDD 209. Alternatively, data of a JDF job input via the external interface unit 202 is processed by the JDF print function program 504, and the resulting image data is stored.

In FIG. 16A, a job list shows that three sets of job data are stored in the HDD 209. That is to say, the three sets of job data are the jobs whose job names are designated as “Job A”, “Job B”, and “Job C”. In this diagram, “Job C” of these multiple stored jobs is selected, and print processing of image data of the job “Job C” is started by pressing a “Start print” button 1601 in this state. On the other hand, pressing an “Edit job” button 1602 in this state makes it possible to change print settings with respect to the job “Job C”.

FIG. 16B is a diagram showing an example of page information constituting “Job C” that is in the selected state in FIG. 16A. The image data of this job is composed of 45 pages of image data, and is divided into three sections. That is to say, the image data consists of a first section (a first chapter) composed of pages 1-15, a second section (a second chapter) composed of pages 16-35, and a third section (a third chapter) composed of pages 36-45. In the following description, the sections will be referred to as “chapters”. Information on a page range constituting each of these chapters is contained in print settings that are held along with “Job C”. Moreover, print settings constituting a chapter can be created by, for example, a PDL print job or a JDF print job sent from the computer 101.

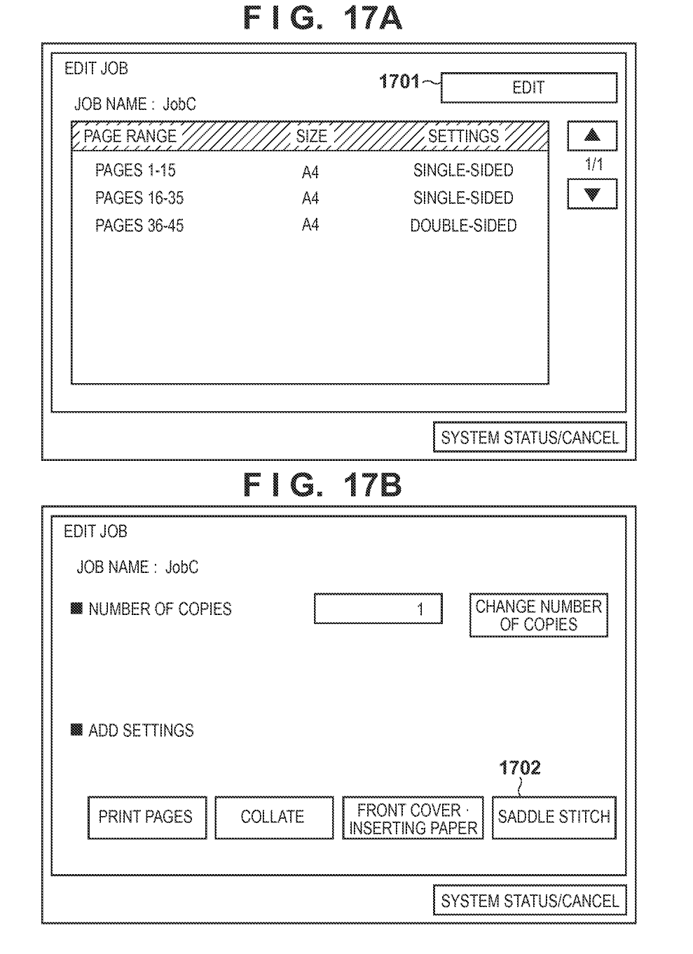

FIG. 17A is a diagram showing an example of a job edit screen that is displayed in the case where the “Edit job” button 1602 in FIG. 16A has been pressed. Page range information regarding the three chapters shown in FIG. 16B and part of information on settings of each chapter are displayed. Here, the first and the second chapters are set to A4 size and single-sided printing, and the third chapter is set to A4 size and double-sided printing.

In this state, if an “Edit” button 1701 in FIG. 17A is pressed, the screen changes to a screen for changing the setting information of the job “Job C” shown in FIG. 17B. In FIG. 17B, buttons for changing various settings regarding a job are disposed.

In the second embodiment, descriptions regarding functions that are little related to the square back process and setting change buttons corresponding to those functions will be omitted. A “Saddle stitch” button 1702 is a button for changing settings regarding the saddle stitching process in the job “Job C”.

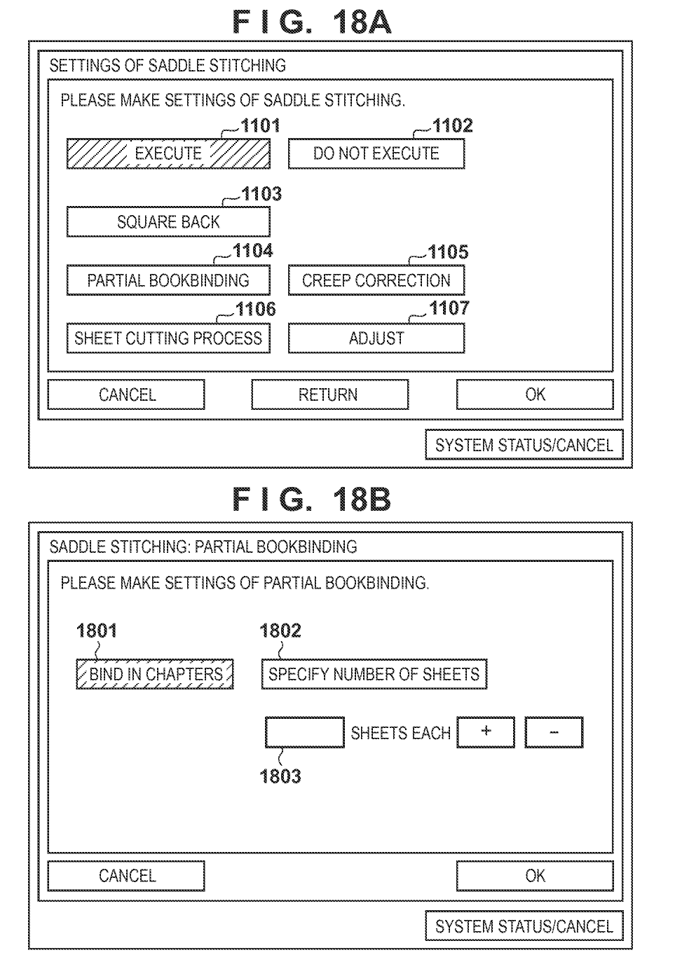

FIG. 18A is a diagram showing an example of a setting screen that is displayed after the “Saddle stitch” button 1702 has been pressed in FIG. 17B. In FIG. 18A, the same portions as those in FIG. 11A are denoted by the same reference numerals. Items that can be set and functions associated with various setting buttons in this diagram are the same as those in FIG. 11A of the first embodiment, and therefore descriptions thereof are omitted here. In FIG. 18A, the “Execute” button 1101 for setting so as to execute saddle stitching is selected.

FIG. 18B is a diagram showing an example of a setting screen of partial bookbinding that is displayed after the “Partial bookbinding” button 1104 has been pressed on the setting screen in FIG. 18A. As functions that can be set with respect to partial bookbinding of the BOX function according to the second embodiment, a “Bind in chapters” button 1801 and a “Specify number of sheets” button 1802 are provided. In FIG. 18B, the “Bind in chapters” button 1801 is selected. In this case, when executing “Job C”, a total of three pieces of saddle-stitched output matter respectively corresponding to the chapters in FIG. 16B or 17A are generated. That is to say, the first saddle-stitched output matter consisting of pages 1-15, which corresponds to the first chapter, is generated. Also, the second saddle-stitched output matter consisting of pages 16-35 corresponding to the second chapter and the third saddle-stitched output matter consisting of pages 36-45 corresponding to the third chapter are generated.

On the other hand, in the case where the “Specify number of sheets” button 1802 in FIG. 18B is pressed, saddle-stitched output matter is not generated on a chapter-by-chapter basis. Instead, all the pages are treated as a single chapter, and saddle-stitched output matter is generated in units of the number of sheets specified in a box 1803 for specifying the number of sheets.

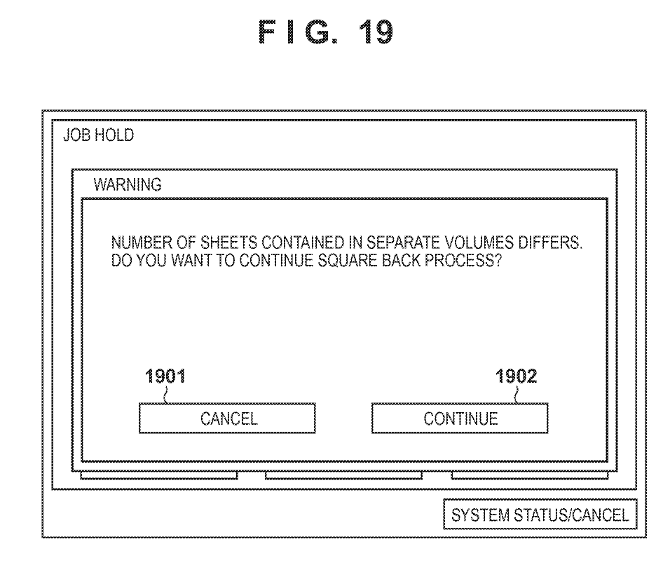

FIG. 19 is a diagram showing an example of display of a warning screen according to the second embodiment.

Here, it is assumed that in the job “Job C”, the “Bind in chapters” button 1801 in FIG. 18B is selected, and the square back process is selected by the “Square back” button 1103 in FIG. 18A. An example of a screen that is displayed if the “Start print” button 1601 shown in FIG. 16A is pressed in this state is shown.

The job “Job C” is composed of a plurality of chapters as shown in FIG. 16B, and the number of pages constituting the chapters differs from chapter to chapter. With respect to such a job, in the case where square back is set, and an adjustment amount for the square back process shown in FIG. 13 is specified, there is a risk that a problem as described below may arise. That is to say, separate volumes of bound matter corresponding to the individual chapters are produced, and the number of sheets of the separate volumes differs from one volume to another. Therefore, an appropriate pressure of the compression roller 706 that is required in order to obtain bound output matter as intended by the user differs from one volume of bound matter to another. Nevertheless, since the fold amount (pressure) is set in FIG. 13, the pressing process is performed in accordance with the set pressure, and therefore there is a possibility that the pressure may be excessive or deficient for some volumes of bound matter. That is to say, whatever adjustment amount is set through the screen in FIG. 13, it is not possible to apply proper pressure with respect to all of the separate volumes each composed of a different number of sheets.

FIG. 19 is a diagram showing an example of a screen for displaying warning to the user in such a case as described above. Here, if a “Cancel” button 1901 is pressed, print processing of the job “Job C” is interrupted. That is to say, in the case where the division into the separate volumes results in the possibility that resulting printed matter corresponding to each chapter may not be a desired result of printing, the user can confirm this and thereafter instruct to cancel processing. In this case, the user can, for example, return to the screen in FIG. 16A again, start various settings over from the “Edit job” button 1602, and thereafter perform processing of the job “Job C” based on different print conditions.

On the other hand, if a “Continue” button 1902 is pressed, continuation of processing of the job “Job C” is instructed. That is to say, in the case where the division into the separate volumes results in the possibility that resulting printed matter corresponding to each chapter may not be a desired result of printing, the user can confirm this and thereafter instruct to continue processing. Thus, it is possible for the user to use these functions as appropriate for the situation based on the level of strictness of form control required for the bound output matter or judgment during operation.

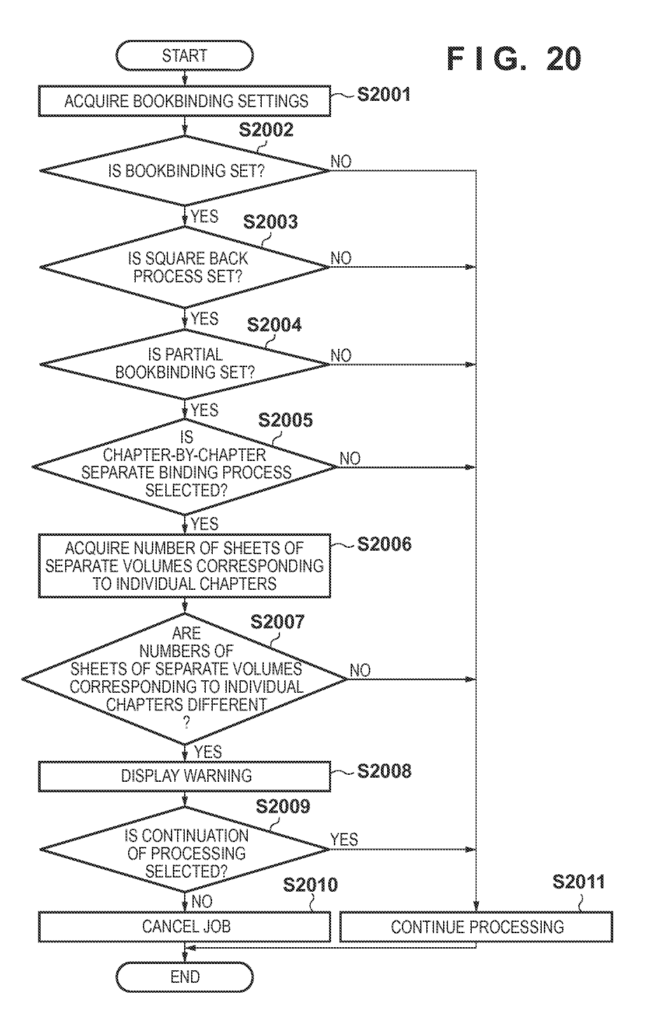

FIG. 20 is a flowchart for describing processing related to display of a warning screen in processing of the BOX function according to the second embodiment. This processing is realized by the controller 205 executing a program loaded into the RAM 208.

This process is started when the “Start print” button 1601 in FIG. 16A is pressed. First, in step S2001, the controller 205 acquires setting information regarding saddle stitching of a job to be processed.

Next, the processing proceeds to step S2002, in which the controller 205 determines whether the saddle stitching process is selected in the job (e.g., “Job C”) based on the setting information acquired in step S2001. If a bookbinding process is not set, the processing proceeds to step S2011.

In step S2011, processing in the case where it is not necessary to display the warning screen shown in FIG. 19 is performed, and the controller 205 continues processing as is. On the other hand, if it is determined in step S2002 that the bookbinding process is set, the processing proceeds to step S2003, in which the controller 205 determines whether the square back process is set in the job. If it is determined here that the square back process is not set, the processing proceeds to step S2011, while if it is determined that the square back process is set, the processing proceeds to step S2004. In step S2004, the controller 205 determines whether the partial bookbinding process is selected in the job. If it is determined that the partial bookbinding process is not selected, the processing proceeds to step S2011, while if the partial bookbinding process is selected, the processing proceeds to step S2005. In step S2005, the controller 205 determines whether a chapter-by-chapter separate binding process of the partial bookbinding process is selected in the job. Here, if it is determined that the chapter-by-chapter separate binding process is not selected, the processing proceeds to step S2011; however, if not, the processing proceeds to step S2006. In step S2006, the controller 205 has determined that in this job, saddle stitching, square back, partial bookbinding, and the chapter-by-chapter separate binding process are selected. Therefore, in step S2006, the controller 205 acquires information on the number of sheets contained in each of the chapters composing the job to be printed. Next, the processing proceeds to step S2007, in which it is determined whether or not the numbers of sheets contained in the separate volumes corresponding to the individual chapters obtained in step S2006 are the same. Here, if it is determined that the numbers of sheets contained in the separate volumes corresponding to the individual chapters are the same, the processing proceeds to step S2011, while if the numbers of sheets are not the same, the processing proceeds to step S2008. In step S2008, the controller 205 displays a warning screen as shown in FIG. 19 on the console unit 204. Next, the processing proceeds to step S2009, in which the controller 205 determines which of the “Cancel” button 1901 and the “Continue” button 1902 has been pressed. If it is determined that the “Continue” button 1902 has been pressed, the processing proceeds to step S2011, in which the controller 205 continues to execute this job. In the case of continuing execution of the job, the controller 205 performs control so as to execute the pressing process at a pressure set on the screen shown in FIG. 13. It should be noted that if separate binding has been performed, the controller 205 performs control so as to execute the pressing process with respect to each of the separate volumes of saddle-stitched output matter composed of the sheets. On the other hand, if the “Cancel” button 1901 has been pressed, the processing proceeds to step S2010, in which the controller 205 performs processing for interrupting execution of the job. For example, the controller 205 executes processing for returning display to the screen in FIG. 16A.

It should be noted that in the case where the numbers of sheets contained in the separate volumes are different from each other, the pressure value of the compression roller 706 may be changed for each volume.

Alternatively, if the differences in the number of sheets contained in each of the separate volumes are less than or equal to a predetermined value, the square back process may be performed with the same pressure value of the compression roller 706. Alternatively, if the differences in the number of sheets contained in each of the separate volumes are greater than or equal to the predetermined value, the square back process may be performed with different pressure values of the compression roller 706 for different volumes.

The present invention is not limited to the above-described embodiments, and various modifications (including organic combinations of embodiments) can be made based on the gist of the present invention. It is to be understood that such modifications are not excluded from the scope of the present invention. For example, although the above-described various types of control were mainly conducted by the controller 205 of the printer apparatus 1000 in the embodiments, a configuration in which a part or all of the above-described various types of control can be executed by an external controller or the like in a chassis separate from the printer apparatus 1000 may also be adopted. Although various examples and embodiments of the present invention have been described above, it will be understood by those skilled in the art that the gist and scope of the present invention are not limited to the specific description in the present specification.

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-203299, filed

Sep. 10, 2010, which is hereby incorporated by reference herein in its entirety.

What is claimed is:

1. A sheet processing apparatus that performs sheet processing with respect to a plurality of printed sheets, comprising:
a bookbinding unit adapted to perform a bookbinding process with respect to a plurality of sheets;
a spine forming unit adapted to apply pressure to a spine of a stack of sheets bound by the bookbinding unit to flatten the spine;
a setting unit adapted to set a pressure value of the pressure applied to the spine by the spine forming unit; and
a control unit adapted to control application of the pressure to the spine by the spine forming unit in accordance with the pressure value set by the setting unit.

2. The sheet processing apparatus according to claim 1,
wherein the spine forming unit comprises:
a press roller for pressing and fixing the stack of sheets against a base; and
a compression roller that moves along the spine of the stack of sheets fixed by the press roller and applies pressure to the spine, and
the control unit changes a distance between the spine and the compression roller in accordance with the pressure value set by the setting unit.

3. The sheet processing apparatus according to claim 1,
wherein the bookbinding unit comprises:
a saddle stitching unit adapted to saddle stitch the plurality of sheets; and
a folding unit adapted to fold the stack of sheets saddle-stitched by the saddle stitching unit.

4. The sheet processing apparatus according to claim 1, further comprising:
an instruction unit adapted to provide an instruction to divide the plurality of sheets into a plurality of sections each consisting of a plurality of sheets and perform bookbinding by the bookbinding unit on a section-by-section basis; and
a display control unit adapted to display a warning to a user if, in the case where the numbers of sheets of the sections instructed by the instruction unit are not the same, it is set so as to control application of the pressure to the spine by the spine forming unit in accordance with the pressure value set by the setting unit.

5. A method of controlling a sheet processing apparatus that performs sheet processing with respect to a plurality of printed sheets, the method comprising:
a bookbinding step of a bookbinding unit of the sheet processing apparatus performing a bookbinding process with respect to a plurality of sheets;
a spine forming step of a spine forming unit of the sheet processing apparatus applying pressure to a spine of a stack of sheets bound in the bookbinding step to flatten the spine;
a setting step of a setting unit of the sheet processing apparatus setting a pressure amount of the pressure applied to the spine in the spine forming step; and
a controlling step of a control unit of the sheet processing apparatus controlling application of the pressure to the spine in the spine forming step in accordance with the pressure amount set in the setting step.
